(19) United States
(12) Patent Application Publication
(10) Pub. No.: US 2016/0179417 A1
(43) Pub. Date: Jun. 23, 2016

(54) INDICATING A DIMENSION OF A SEQUENTIAL ACCESS STORAGE MEDIUM SUBJECT TO EXPANSION AND CONTRACTION

(71) Applicant: HEWLETT PACKARD ENTERPRISE DEVELOPMENT LP, Houston, TX (US)

(72) Inventors: Donald J Fasen, Boise, ID (US); Jonathan Peter Buckingham, Bristol (GB); John D Hampton, Boise, ID (US)

(21) Appl. No.: 14/908,531

(22) PCT Filed: Jul. 30, 2013
(86) PCT No.: PCT/US2013/052718

§ 371 Date: Jan. 28, 2016

(51) Int. Cl. G06F 3/06; G11B 5/008

(52) U.S. Cl. CPC G06F 3/0619; G11B 5/00817; G06F 3/0653; G06F 3/0682

(57) ABSTRACT

A technique includes reading or writing at least one unit of data to or from a sequential access storage medium, which has a physical dimension that is subject to expansion and contraction; and reading or writing a value that indicates the physical dimension.

### BACKGROUND

As the track width, or pitch, continues to decrease for magnetic storage tape, the dimensional stability of the tape has an ever-increasing influence on whether read elements of the drive register with the tracks of the tape. In this manner, the width of the tape may laterally expand and contract over time due to such factors as changes in the ambient environment (changes in humidity and/or temperature of the tape, as examples) and/or changes in the tape tension. Therefore, the location of a given track of the tape may change over time between a time that the data is written to the track and a later time that data is read from the track.

### BRIEF DESCRIPTION OF THE DRAWINGS

FIG. 1 is a schematic diagram of a computer system according to an example implementation.

FIG. 2 is a flow diagram a depicting a technique to store a value on a sequential access storage medium indicating a physical dimension of the medium according to an example implementation.

FIG. 3 is a flow diagram depicting a technique to read medium expansion values from a sequential access storage medium and apply the values according to an example implementation.

FIG. 4A is an illustration of the storage of datasets, dataset information tables and medium expansion values on a magnetic storage tape according to an example implementation.

FIG. 4B is an illustration of a synchronized track dataset according to an example implementation.

FIG. 4C is an illustration of synchronized codeword objects according to an example implementation.

FIG. 5 is a flow diagram depicting a technique to read medium expansion values from a sequential access storage medium and a cartridge memory and apply the values according to an example implementation.

FIG. 6 is a flow diagram depicting a technique to store medium expansion values on a sequential access storage medium an in a cartridge memory according to an example implementation.

### DETAILED DESCRIPTION

Techniques and systems are disclosed herein for purposes of writing values to and reading values from a sequential access storage medium (a magnetic storage tape, for example), which represent, or indicates when user data is written to and read from the medium, so that dimensional stability correction may be performed. For the specific examples that are disclosed herein, the sequential access storage medium is a magnetic storage tape, which is housed in a corresponding physical tape cartridge and is accessed by turning reels of the cartridge. Moreover, in accordance with specific example implementations that are disclosed herein, the storage of data may comply with a Linear Tape Open (LTO) standard (the LTO-6 Standard, as an example).

In general, as the track width, or pitch, is being reduced from one LTO generation to the next, the dimensional stability of the tape becomes a larger portion of the track misregistration budget. In general, the dimensional stability of the tape refers to the tendency of the tape width to laterally expand and contract due to such factors as changes in the ambient environment (humidity and temperature, as examples), as well as changes to the applied tension, which is exerted by the tape drive on the tape. This lateral contraction and expansion may cause the location of a given track (an outer track, for example) of the tape to significantly change between a time that data is written to the track and a later time that the stored data is read from the track. Without an appropriate tape dimensional stability (TDS) correction to account for this change, one or multiple read elements (outer read elements, for example) of the tape drive may not register properly with the appropriate track(s), causing data to be misread.

In accordance with example implementations, a tape drive system is constructed to apply TDS correction to a tape being read for purposes of accommodating the difference in a lateral tape dimension, or tape width, between the time when the data was written to the tape and the lateral tape dimension, or tape width, during the current read operation. More specifically, systems and techniques are disclosed herein that involve writing and reading “medium expansion values” to and from the tape. Although called a “medium expansion value” herein, it is understood that the value, in general, identifies, or indicates, a physical dimension of the medium (a width of a tape, for examples discussed herein) at a given time and in general, different medium expansion values may be compared for purposes of identifying the degree that tape has expanded or contracted between the time when the data was written to the medium and the time when the data is read back from the medium. Therefore, the medium expansion values may be written during the write process to the data channels so that these medium expansion values are available for TDS correction during the read process that retrieves the written data.

In accordance with example implementations, the medium expansion values are written to the tape with correction codes (error correction codes (ECCs), for example), as the medium expansion values are stored as part of dataset information tables (DSITs) on the tape. Moreover, for reasons discussed herein, medium expansion values may also be selectively written to the cartridge memory (CM) of the tape cartridge,

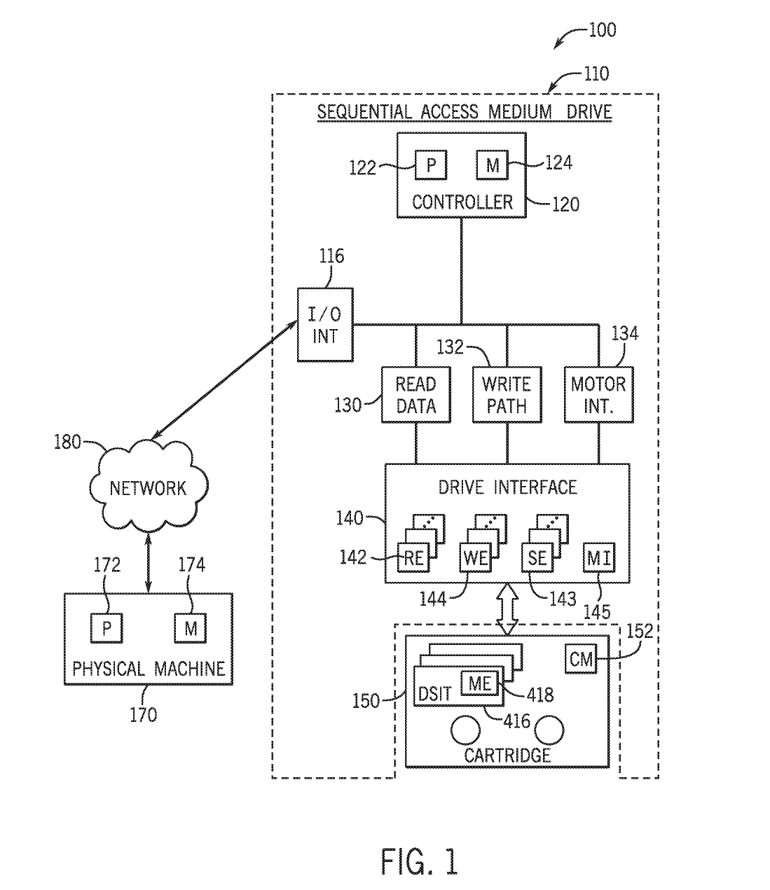

Turning now to a more specific example, FIG. 1 depicts an example computer system 100, which for this example, includes one or multiple sequential medium access drives, such as example sequential access medium drive 110. In accordance with example implementations that are disclosed herein, the drive 110 is a magnetic storage tape drive, which reads from and writes to magnetic storage tape pursuant to an LTO standard. For the example implementations that are disclosed herein, the magnetic storage tape is stored in on reels contained in a physical housing, or cartridge 150. The drive 110 may be a drive other than a tape drive and/or may use a standard other the LTO standard to read data from and write data to a sequential access medium, in accordance with further implementations.

In general, one or more physical machines may access the drive 110 for purposes of storing data on the tape and/or retrieving data from the tape. For the example of FIG. 1, a physical machine 170 is coupled to a network 180 for purposes of accessing the sequential access medium drive 110.

The physical machine 170 is an actual machine that is made up of actual hardware and actual machine executable instructions, or “software.” Thus, in general, the physical machine 170 includes such hardware as a processor 172 (one or multiple central processing units (CPUs), for example) and a memory 174 (a non-transitory memory, such as semiconductor storage, optical storage, and so forth), which may store machine executable instructions, which are executed by the processor 172. The physical machine 170 may be a client, a server, a storage appliance, a laptop, a tablet computer, thin client, a smartphone and so forth, depending on the particular implementation.

The network 180 represents one or multiple types of network fabric, such as, local area network (LAN) fabric, wide area network (WAN) fabric, Internet-based fabric, Fiber Channel, a Small Computer System Interface (SCSI), or a combination of one or more of these fabrics.

In general, the sequential access medium drive 110 includes a controller 120 that, in general, collectively represents the control functions for the drive 110. The controller 120 controls a drive interface 140 for purposes of writing data to and reading data from the medium cartridge 150 that may be inserted into a bay of the drive 110. In this regard, the drive interface 140 may include such features as motors coupled to reels of the physical cartridge 150, read elements 142, write elements 144, servo elements 143 and various other components, such as sense amplifiers, positioners, pulse detectors, error correction code (ECC) engines, and so forth, as can be appreciated by the skilled artisan.

As depicted in FIG. 1, the drive interface 140 may further include a memory interface 145 for purposes of writing to and reading from a cartridge memory 152 of the cartridge 150. In general, the cartridge memory 152 may be non-volatile semiconductor memory (i.e., a memory that may be accessed using random accesses, as compared to the sequential access used for the tape, for example). As examples, the cartridge memory 152 may be a flash memory. Regarding of the memory technology affiliation of the cartridge memory 152, the memory 152 stores data identifying details about the identity and use of the cartridge 150; and in example implementations, the cartridge memory 152 stores medium expansion values, as further discussed herein.

Among its other features, the sequential access medium drive 110 includes a read data path 130, a write data path 132, a drive motor interface 134, and an input/output (I/O) interface 116, which communicates with the network fabric 180. As also depicted in FIG. 1, the controller 120 may include one or multiple processors 122 (one or multiple CPUs, microcontrollers, and so forth), as well as a memory 124 (a non-transitory memory, such as semiconductor storage, optical storage, and so forth) that may store data, program instructions, and so forth, for processing by the processor(s) 122.

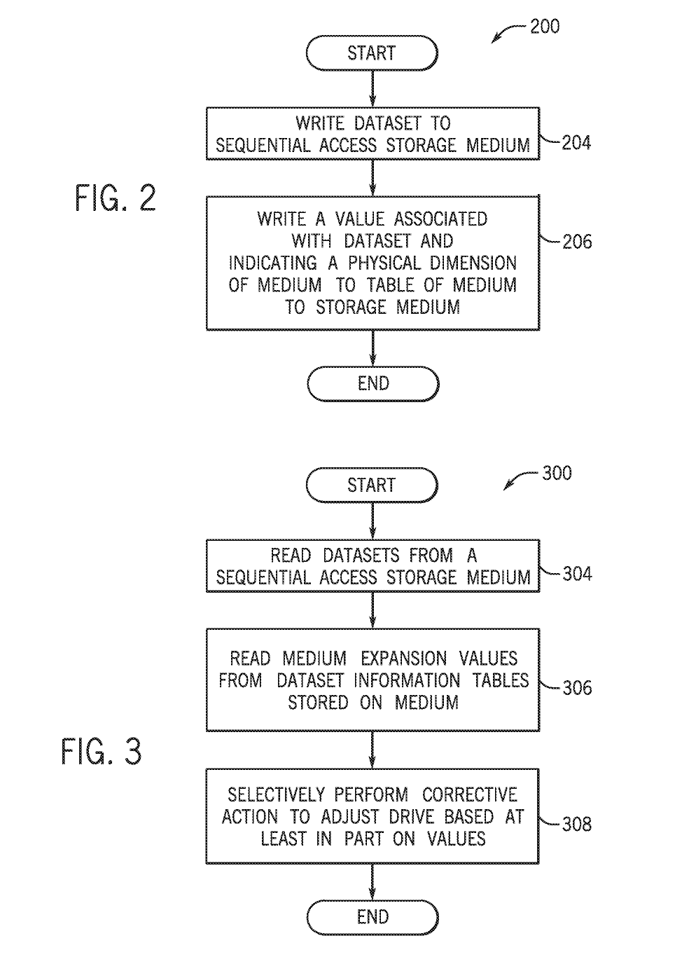

In accordance with example implementations, the controller 120 performs a technique 200 that is depicted in FIG. 2. Referring to FIG. 2 in conjunction with FIG. 1, pursuant to the technique 200, the controller 120 writes (block 204) a dataset to a sequential access medium and writes (block 206) a value that is associated with the dataset and represents, or indicates, a physical dimension (a tape width, for example) of the medium to a table that is also stored on the medium.

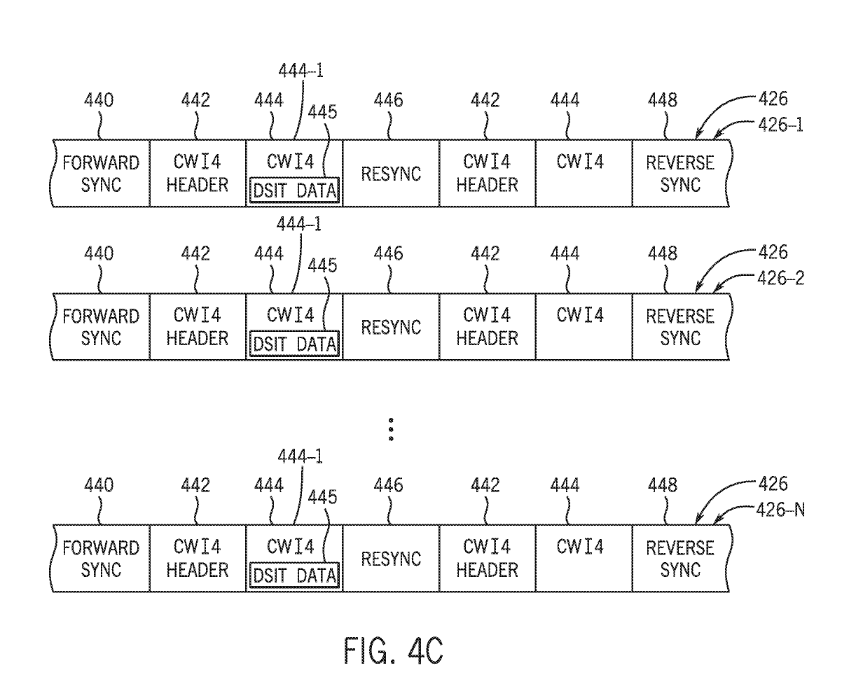

More specifically, referring to FIG. 4A, in conjunction with FIG. 1, in accordance with example implementations, the data may be sequentially stored on a magnetic storage tape 400 in data units, which are called “datasets 410” in FIG. 4A. In general, each dataset 410 contains a unit of user data and an associated dataset information table (DSIT) 416, which contains data representing administrative information about the user data. In accordance with example implementations, a medium expansion value 418 is stored in the DSIT 416 and indicates, or represents, a physical dimension of the tape 400 at the time that the dataset 410 is written to the tape 400, i.e., a value that absolutely or relatively identifies a physical lateral dimension, or width, of the portion of the tape containing the dataset 410. Because the medium expansion value 418 represents the physical tape dimension at the time the data is written, the medium expansion value 418 is also referred to herein as the as-Written Tape Expansion (WTE) value.

The controller 120 may determine the WTE value in real time or near real time by, for example, measuring a distance between servo tracks of the storage tape.

At a later time, when the dataset 410 is read back potentially under a different condition, which causes a difference in the lateral dimension of the tape, the controller 120 may compare the current tape expansion during the read operation (also referred to as the “RTE value” herein) so that the controller 120 may take the appropriate TDS corrective action.

More specifically, the controller 120 may perform adjustments to account for differences between the WTE and the RTE values for a given dataset 410 for purposes of adjusting the RTE value so that the RTE and WTE values coincide (within a predetermined percentage (ten percent, for example) of each other, for example). This corrective action may involve, as examples, adjusting a tension on the tape by adjusting the relative torques applied by the drive 110 to the reels of the cartridge 150. In this manner, in accordance with example implementations, the controller 120 may also control the tension in the tape. In further example implementations, the drive 110 may contain a separate tape tensioning system, which is independent from the controller 120. In accordance with example implementations, the tension in the tape is controlled by a differential torque between a motor of the drive 110 coupled to one reel of the cartridge 150 and another motor of the drive 110, which is coupled to the other reel of the cartridge 150. In this manner, the tape tension may be controlled by relatively accurately controlling the torque in each motor and adjusting for such factors as the amount of tape on each reel, the drag across the tape head, the thickness of the tape and the like. In further example implementations, the tension in the tape may be controlled using a spring-loaded or a servo-driven capstan. Both types of tape tensioning systems may be used with or without a tension sensor.

In accordance with further implementations, the tape tension may be controlled by regulating a thermal energy that is applied by a read element head heater. Thus, many variations are contemplated, which are within the scope of the appended claims.

A particular advantage in writing the WTE value is written in the dataset 410 along with the user data is that there is no uncertainty as to whether the WTE applies to the user data, even when the user data is written in an append operation in which the associated dataset 410 is appended onto the storage tape at a different time (and potentially under different conditions that give rise to a different lateral dimension) than the time in which other datasets 410 were written to the tape.

In accordance with example implementations, a given dataset 410 is stored in a distributed fashion among multiple tracks of the storage tape. As such, the DSIT 416 and medium expansion value 418 are also distributed among multiple tracks of the tape, in accordance with example implementations. Moreover, in accordance with example implementations, the data in the DSIT 416, including the medium expansion value 418, are stored with error correction codes (ECCs).

In accordance with example implementations, each dataset 410 collectively represents a set of synchronized track datasets 420 (see an example synchronized dataset 420 of FIG. 4B) that are stored across multiple tracks of the storage tape. Referring to FIG. 4B, in general, dataset separators (DSSs) 422 mark the beginning and end of the synchronized track dataset 420. After the beginning DSS 422, the synchronized dataset 420 contains a first variable-frequency oscillator pattern (VFO1) 424, which allows discrimination of a first synchronized codeword object (SCO) 426 from the beginning DSS 422. Additional variable-frequency oscillator patterns (VFO2) separate the SCOs 426; and a VFO1 pattern separates the last SCO 426 of the synchronized dataset 420 from the end DSS 422. In general, each SCO 426 contains codewords and codeword pairs that represent the user and DSIT data.

In this manner, referring to FIG. 4C, in accordance with an example implementation, user data and an associated DSIT (containing an associated medium expansion value) of a given dataset may be stored on N tracks of the storage tape using the above-described SCOs 426, such as N example SCOs 426-1, 426-2 . . . 426-N of FIG. 4C. Each SCO 426 is delimited at its ends by a forward synchronization field 440 (when the SCO 426 is accessed in a first direction) and a reverse synchronization field 448 (when the SCO 426 is accessed in the opposite direction). The SCO 426 contains a pair of a codeword interleave four (CWI4) header 442 and associated CWI4 data 444, which is separated from another pair of a CWI4 header 442 and CWI4 data 444 by a resynchronization pattern 446.

In example implementations, the datatset complies with the LTO standard; and a dataset may contain a few thousand CWIs (3072 in LTO6, for example). In accordance with example implementations, one of these CWIs, may be dedicated as containing the DSIT, such as CWI data 444-1, and the other CWIs may contain user data. As depicted in FIG. 4C, the CWI4 data 444-1 contains DSIT data 445, so that the CWI4 data 444 for all of the SCOs 426 for a given set of synchronized track datasets 420 (see FIG. 4B) collectively represent a dataset containing user data and a DSIT.

Thus, in accordance with example implementations, a particular set of CWI4 data 444 contains the WTE data for the associated dataset. The particular CWI4 data 444 that contains the WTE value uses a center element of a read head so that the current tape expansion/contraction does not render the WTE value unreadable.

In accordance with example implementations, the WTE value may be written along with a C1 ECC so that the ECC code may be applied to the retrieved data for the WTE. Thus, the WTE value may be extracted from the DSIT after the user data is read. Because WTE values may vary relatively slowly as the WTE values are being written to the storage tape, the above-described delays, or lag, in reading the WTE values from the storage tape and processing the WTE values using ECC may not be an issue.

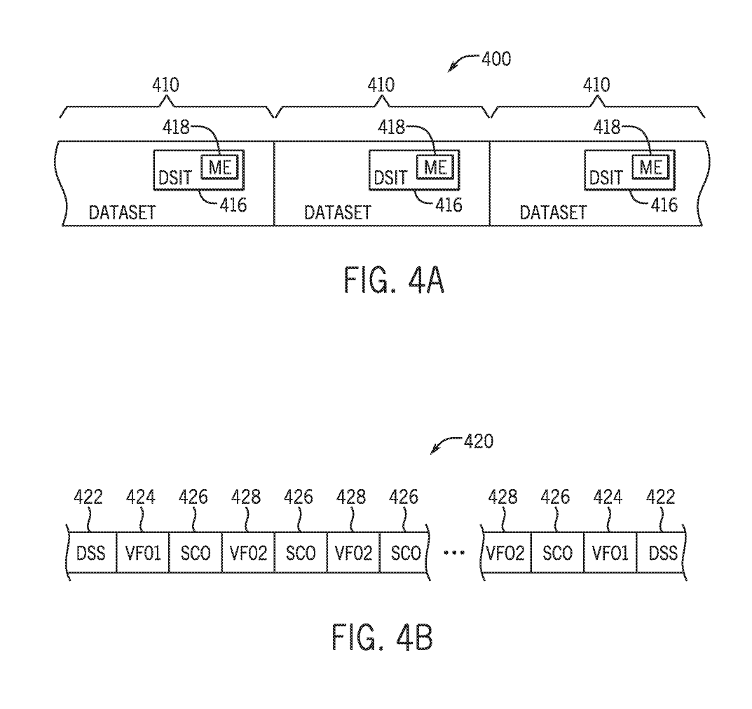

Thus, referring to FIG. 3 in conjunction with FIG. 1, in accordance with example implementations, a technique 300 includes reading (block 304) datasets from a sequential access storage medium and reading (block 306) medium expansion values from dataset information tables that are stored on the medium. The technique 300 includes selectively performing corrective action to adjust the drive based at least in part on the medium expansion values, pursuant to block 308.

For purposes of accommodating scenarios when the WTE value stored on the storage tape may change relatively rapidly (i.e., change at a rate at which the tape drive reading the tape may not otherwise be capable of performing TDS corrective action to keep up with the change, the controller 120 may write one or multiple WTE values to the cartridge memory 152 (see FIG. 1). In accordance with example implementations, the cartridge memory 152 is a non-volatile memory, which stores information, in general, regarding to the use of the storage tape, the identity of the cartridge 100 and one or multiple WTE entries. In general a WTE-related entry stored in the cartridge memory 152 contains two components: a WTE value and a location of the storage tape for which the WTE value is to be applied.

As a more specific example, in accordance with some implementations, WTE values may be stored on both the storage tape and in the cartridge memory 152, so that the controller 120, when reading data from the storage tape and applying TOS corrective action, may use a combination of WTE values that are retrieved from the DSITs and the cartridge memory for purposes of performing the TDS correction.

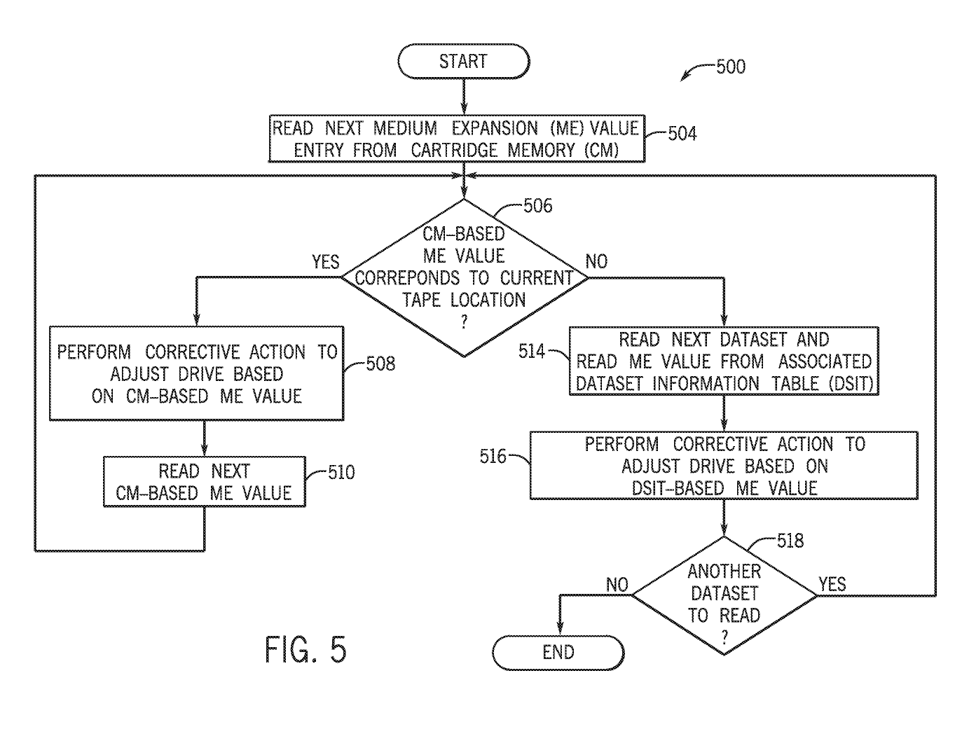

More specifically, referring to FIG. 5 in conjunction with FIG. 1, in accordance with example implementations, the controller 120 performs a technique 500 for purposes reading data from a tape cartridge that contains a cartridge memory storing one or multiple medium expansion-related entries and a tape that stores one or multiple medium expansion values in DSIT(s). The technique 500 includes the controller 120 reading (block 504) the next medium expansion-related entry from the cartridge memory, which contains a medium expansion value and a location of the tape associated with the expansion. If the controller 120 determines (decision block 506) that the read cartridge memory-based value corresponds to the current tape location, then the controller 120 performs (block 508) corrective action to adjust the drive based on the read and the currently determined medium expansion value. The controller 120 then reads (block 510) the next medium expansion value-related entry from the cartridge memory and control returns to decision block 506.

If in decision block 506 the controller 120 determines that the read medium expansion value read from the cartridge memory does not correspond to the current tape location, then the controller 120 proceeds to read (block 514) the next dataset from the storage tape, including reading the associated medium expansion value from the associated DSIT. Based on the medium expansion value read from the DSIT, the controller 120 may perform (block 516) TDS corrective action to adjust the drive. Subsequently, if the controller 120 determines (decision block 518) that more datasets are to be read, control returns to decision block 506.

When data is written to the storage tape, the decision of whether to store a given medium expansion value-related entry in the cartridge memory 152 depends on whether relatively large changes in the value are encountered. As an example, two scenarios may occur, which give rise to a relatively large time rate of change in the medium expansion value. First, a relatively large change may occur due to the writing of data occurs across a section of the storage tape, which has a different usage history. For purposes of identifying such portions of the tape, in accordance with example implementations, the controller 120 evaluates a running history of the real time medium expansion values (evaluates a moving window average, for example); compares the running history average to the current medium expansion value; and based on this comparison, determines if a write of a corresponding medium expansion value-related entry to the cartridge memory 152 is to be performed.

As another example, the controller 120 may predict a relatively large change in the medium expansion value when a data append occurs under different environmental conditions from the data that was written previously to the tape. For example, for an append operation, the controller 120 may compare the medium expansion value from the DSIT associated with the originally-written data to the current real time (or near real time) medium expansion value to determine if writing a medium expansion value-related entry to the cartridge memory 152 is warranted.

In accordance with some example implementations, the controller 120 uses a threshold comparison for purposes of determining whether a medium expansion difference between the WTE and RTE values is sufficient to initiate writing a medium expansion value-related entry to the cartridge memory 150. As an example, a value of about 250 nanometers (nm) of medium contraction/expansion may be used as the threshold. Other thresholds may be used, in accordance with further implementations.

The threshold is a tradeoff between a relatively small threshold that may cause an excessive number of medium expansion value-related entries to be written to the cartridge memory 150 and a relatively large threshold in which relatively few medium expansion value-related entries are written to the cartridge memory 150, thereby resulting in the inability of the TDS correction to be adequately maintained because of the lag in the reading/processing of medium expansion values from the DSITs.

During data reads, the controller 120 compares the current tape location and the real time medium expansion values to the values in the cartridge memory 150. If the read data is in the tape location range of a cartridge memory entry, then the controller 120 compares the real time medium expansion value to the cartridge memory-based medium expansion value to set the corresponding TDS correction.

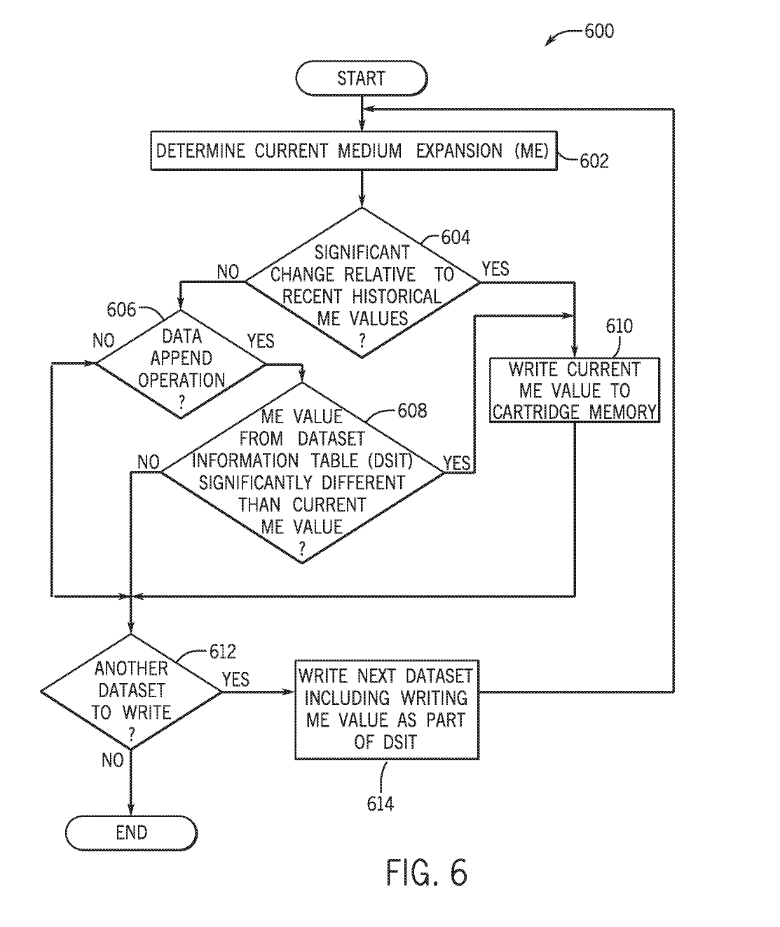

Thus, referring to FIG. 6 in conjunction with FIG. 1, in accordance with example implementations, the controller 120 may perform a technique 600 for purposes of writing data to the storage tape, writing medium expansion values to the DSITs and selectively writing medium expansion value-related entries to the cartridge memory 152. The technique 600 includes the controller 120 determining (block 602) a current, or real time, medium expansion value. If the controller 120 determines (decision block 604) that a significant change in the medium expansion value has occurred, as compared to historical values, the controller 120 writes (block 610) the current medium expansion value-related entry to the cartridge memory, which contains the current medium expansion value and the associated tape location. If, however, the controller 120 determines (decision block 604) that a significant change has not occurred, the controller 120 make a further determination (block 606) whether the current operation is a data append operation. If so, the controller 120 then determines (decision block 608) whether the current, or real time, medium expansion value is significantly different from the medium expansion value that is stored in the DSIT from the originally stored data closest to the part of the tape to be appended. If so, control transitions to block 610, in which the controller 120 writes the current medium expansion value to the cartridge memory in an entry that also includes a corresponding tape location.

Then controller 120 then proceeds to determine (decision block 612) whether another dataset is to be written to the tape, and if so, the controller 120 writes the next dataset to the tape (pursuant to block 614), before control returns to block 602.

While a limited number of examples have been disclosed herein, those skilled in the art, having the benefit of this disclosure, will appreciate numerous modifications and variations therefrom. It is intended that the appended claims cover all such modifications and variations.

What is claimed is:

1. A method comprising:
writing at least one dataset to a sequential access storage medium; and
writing a value associated with the at least one dataset and indicating a physical dimension of the medium subject to expansion and contraction to a dataset information table of the sequential access storage medium.

2. The method of claim 1, wherein writing the datasets comprises:
writing the value to a table associated with administrative information about the at least one dataset.

3. The method of claim 1, wherein the sequential access storage medium is contained in a cartridge, the method further comprising:
writing additional data to a memory of the cartridge indicative of at least one additional value indicating a dimension of the medium subject to expansion and contraction and at least one location of the medium associated with the at least one additional value.

4. The method of claim 3, further comprising:
selectively performing the writing of the additional data based at least in part on a comparison of a current expansion/contraction value to a historical pattern of medium contraction values.

5. The method of claim 3, wherein writing the dataset comprises writing an appended dataset in an appended operation, the method further comprising:
selectively performing the writing of the additional data based at least in part on a comparison of a current medium expansion/contraction value to a medium expansion/contraction value of a dataset stored on the tape prior to the appended expansion being appended.

6. The method of claim 1, wherein writing the at least one dataset comprises writing the at least one dataset to a magnetic storage tape, and the value indicates a lateral dimension of the tape.

7. An apparatus comprising:
at least one write element; and
a controller to use the write element to write a unit of data to a sequential access storage medium stored in a cartridge and selectively write a value indicative of a physical dimension of the medium to a memory of the cartridge separate from the medium, the physical dimension being subject to contraction and expansion.

8. The apparatus of claim 7, further comprising an interface to communicate with the memory to perform random access to at least one storage location the memory.

9. The apparatus claim 7, wherein the controller writes data to the medium indicative of values for the physical dimension at different corresponding times.

10. The apparatus of claim 7, wherein the controller distributes the values among user data stored on the physical medium.

11. The apparatus of claim 10, wherein the controller selectively performs the writing based on a rate at which the values distributed on the physical medium vary.

12. The apparatus of claim 7, wherein the controller further writes the value to the memory as an entry that also includes a location on the medium associated with the physical dimension.

13. An article comprising a non-transitory computer readable storage medium storing instructions that when executed by a computer cause the computer to:
read datasets from a sequential access storage medium subject to contraction and expansion;
read medium expansion values stored in tables on the sequential access storage medium, each of the values being associated with one of the datasets and indicating a value for a physical dimension of the medium associated with the writing of the associated dataset to the sequential storage access medium; and
selectively perform corrective action to adjust a drive for the physical dimension of the medium based on the values.

14. The article of claim 13, wherein the sequential access storage medium is contained in a cartridge, the storage medium storing instructions that when executed by the computer cause the computer to:
read additional data from a memory of the cartridge indicative of at least one additional value for a location of the medium and indicating a value for the physical dimension; and
selectively perform corrective action based on the at least one additional value.

15. The article of claim 13, wherein the sequential access storage medium comprises a magnetic storage tape, and the physical dimension comprises a width of the tape.
